(19) United States
(12) Patent Application Publication
(10) Pub. No.: US 2002/0131564 A1
(43) Pub. Date: Sep. 19, 2002

(54) Portable electronic device capable of pre-recording voice data for notification

(76) Inventor: Jen-Chieh Wu, Taipei Hsien (TW)

Correspondence Address: BACON & THOMAS, PLLC, 4th Floor, 625 Slaters Lane, Alexandria, VA, 22314-1176, US

(21) Appl. No.: 09/808,053

(22) Filed: Mar. 15, 2001

(51) Int. Cl. H04M 1/64; H04M 11/00

(52) U.S. Cl. 379/88.12; 379/88.11; 379/93.17

(57) ABSTRACT

A portable electronic device capable of pre-recording voice data for notification is disclosed. A microphone receives voice data from a user. A speaker is provided for playing the voice data. A voice data processor processes the received voice data and the voice data to be played. A non-volatile memory stores at least one notification item, at least one notification time, and the corresponding voice data pre-recorded by the user via the microphone. A central processing unit is provided for searching voice data related to a notification item from the non-volatile memory when the notification time is reached, and sending the voice data to the speaker for being played, so as to notify the user.

### BACKGROUND OF THE INVENTION

1. Field of the Invention

The present invention relates to a portable electronic device and, more particularly, to a portable electronic device, such as a PDA or a palmtop, which allows a user to pre-record voice data for notification purposes.

2. Description of the Related Art

The fast development of the electronic technology has enabled the electronic device to be miniaturized. For example, the personal digital assistants (PDA) and palmtops have been implemented to be easily carried by the user to satisfy various demands. The typical PDA or palmtop has a reminding functionality that can be set to remind a user on a pre-recorded date and time. The conventional PDA or palmtop utilizes a loudspeaker to produce an alarm sound to notify the user. However, if the user sets up several notifications in a short period of time and when the alarm is activated at the preset time, the user may find it difficult to distinguish the various notifications from each other. Therefore, the user needs to turn on the machine to check the content of the notification, which is quite inconvenient for the user.

### SUMMARY OF THE INVENTION

The objective of the present invention is therefore to provide a portable electronic device capable of pre-recording voice data for notification so as to remind the user. To achieve this objective, the portable electronic device of the present invention includes: a microphone for receiving voice data from a user; a speaker for playing the voice data; a voice data processor for processing the received voice data and the voice data to be played; a non-volatile memory for storing at least one notification item, at least one notification time, and the corresponding voice data pre-recorded by the user via the microphone; a central processing unit for searching voice data related to a notification item from the non-volatile memory when the notification time is reached, and sending the voice data to the speaker for being played, so as to notify the user.

Other objectives, advantages, and novel features of the invention will become more apparent from the following detailed description when taken in conjunction with the accompanying drawings.

### BRIEF DESCRIPTION OF THE DRAWINGS

FIG. 1 is a hardware structure diagram of the portable electronic device in accordance with.

FIG. 2 schematically illustrates the use of the portable electronic device to provide voice notifications to the user.

FIG. 3 is a flowchart of voice data notification control of the portable electronic device in accordance with.

FIG. 4 is a flowchart for a voice data playing procedure of the portable electronic device in accordance with the present invention.

### DETAILED DESCRIPTION OF THE PREFERRED EMBODIMENT

In the following detailed description, numerous specific detailed examples are set forth in order to provide a thorough understanding of the present invention. However, it will be understood by those skilled in the art that the present invention may be practiced without these specific details. In other instances, well known methods, procedures, components, and circuits have not been described in detail so as not to obscure the present invention.

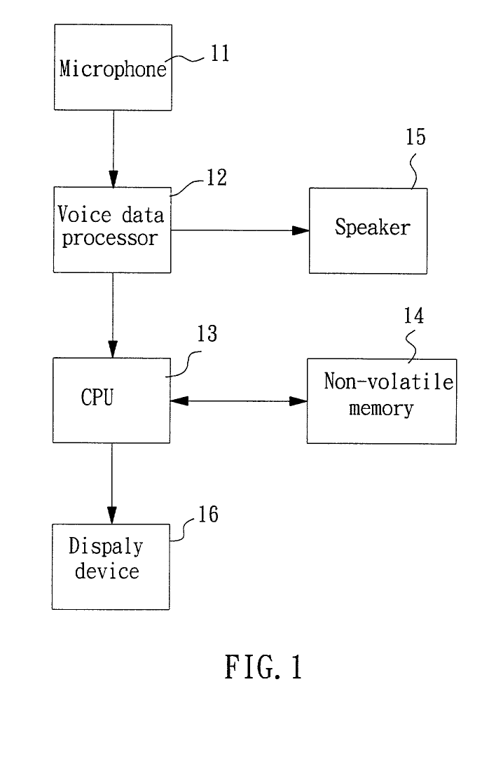

Please refer to FIG. 1, which is a hardware structure diagram of a portable electronic device of the present invention. The portable electronic device comprises a microphone 11, a voice data processor 12, a central processing unit (CPU) 13, a non-volatile memory 14, a speaker 15, and a display device 16. The microphone 11 receives voice data form a user and sends the voice data to the voice data processor 12. The voice data processor 12 utilizes analog-to-digital conversion and selective digital pulse-code modulation to transform human voice data into digital signals, and compresses the signals for being transferred to the central processing unit 13. The central processing unit 13 processes the compressed digital signals for being stored in the non-volatile memory 14. On the contrary, when the portable electronic device is used to play voice data, the central processing unit 13 transfers the compressed digital signals from the non-volatile memory 14 to the voice data processor 12, so as to decompresses and converts the digital signals into the voice data, and the amplifier 15 plays the voice data while the display device 16 displays related information.

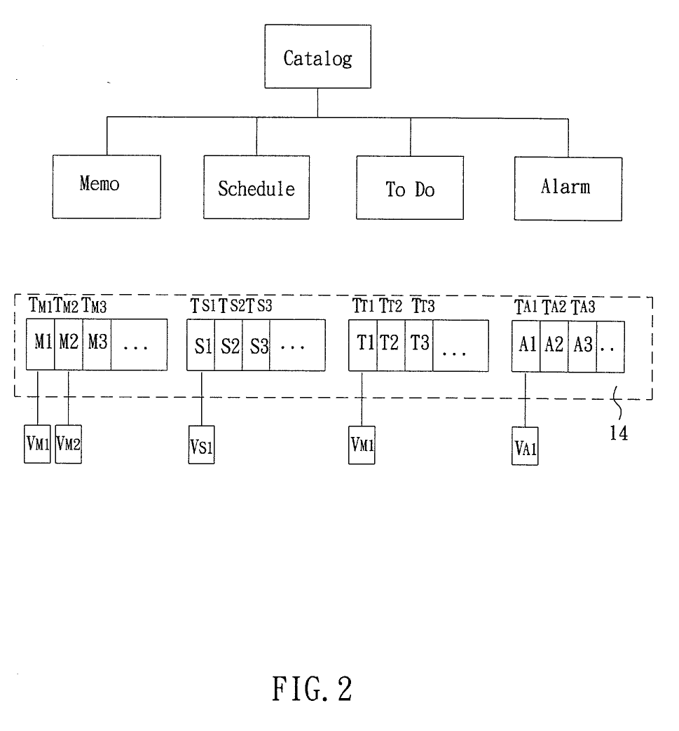

Please refer to FIG. 2, which schematically illustrates the use of the portable electronic device to provide voice notifications to the user. As shown, the portable electronic device provides a plurality of notification functionality items, such as “Memo”, “Schedule”, “To Do”, and “Alarm.” All of these notification functionality items can be used to remind the user at a corresponding notification time. Under each of the functionality items, the user is able to enter the corresponding “Memo” content M, “Schedule” content S, “To Do” content T, or “Alarm” content A. The user can also setup a corresponding notification time (T_{M}, T_{S}, T_{T}, T_{A}) for each of the functionality items. The notification item can be set for a single notification or for repeated notifications. In order to notify the user at the preset time using the voice data, the user needs to pre-record the voice data (V_{M}, V_{S}, V_{T}, V_{A}) in the non-volatile memory 14 for the notification item by using the microphone 11, the voice data processor 12, and the central processing unit 13.

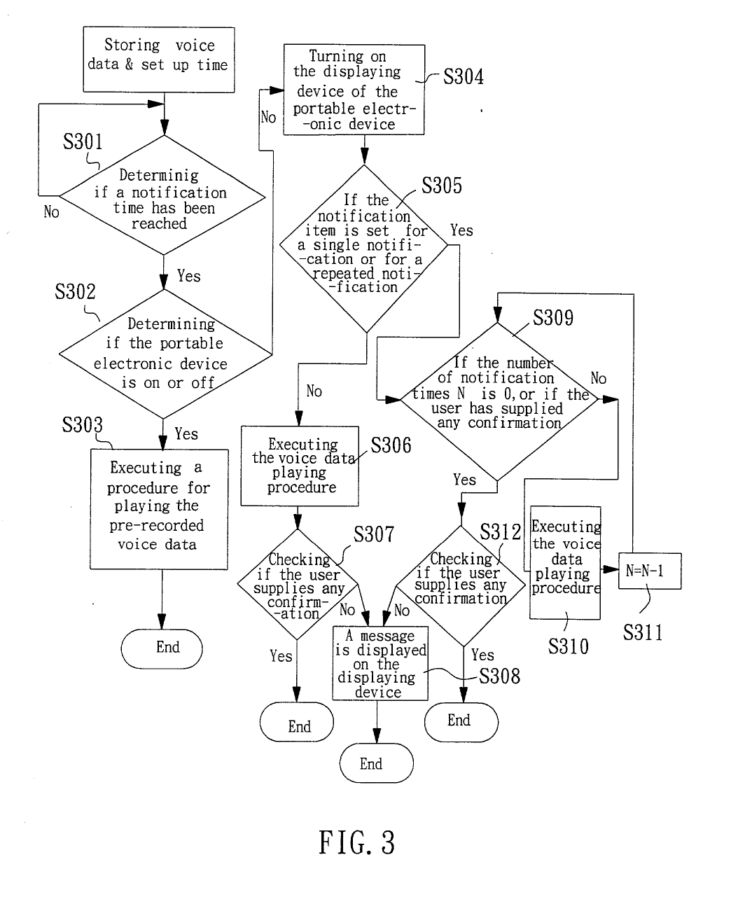

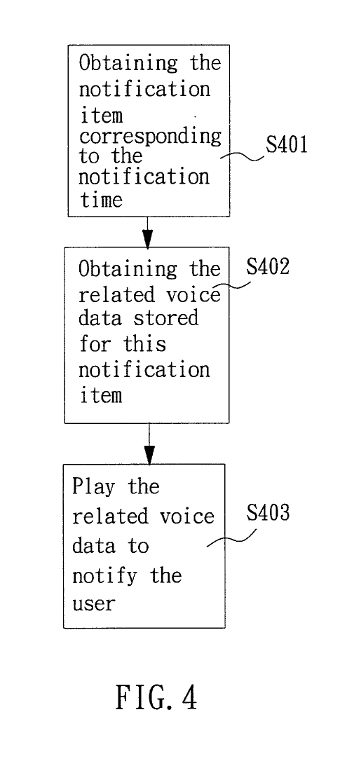

After the user records the voice data and sets up the notification time, the portable electronic device is able to notify the user of a notification event using the pre-recorded voice data. Please refer to FIG. 3. FIG. 3 is a flowchart of voice data reminding control of the portable electronic device of the present invention. An internal-built or externally connected clock for the central processing unit 13 determines if a notification time has been reached (Step 301). If the current time is not a notification time, the portable electronic device will keep waiting. If the current time is a notification time, the central processing unit 13 checks the status of the portable electronic device to determine if the portable electronic device is on or off (Step 302). If the portable electronic device is turned on, the portable electronic device will execute a procedure for playing the pre-recorded voice data (Step 303). Please refer to FIG. 4. FIG. 4 is a flowchart of voice data playing procedure of the portable electronic device of the present invention. As shown in FIG. 4, the central processing unit 13 obtains the notification item corresponding to the notification time (Step 401) and the related voice data stored for this notification item (Step 402). The voice data processor 12 and the speaker 15 thus play the related voice data to notify the user (Step 403).

Please refer to FIG. 3 again. In step 302, if the portable electronic device is off at the notification time, the power for the portable electronic device is then turned on, and the display device 16 of the portable electronic device is turned on (Step 304). Then, the central processing unit 13 determines if the notification item is set for a single notification or for a repeated notification (Step 305). If the notification item is set for a single notification, the portable electronic device will execute the voice data playing procedure shown in FIG. 4 (Step 306), and check if the user supplies any confirmation (Step 307). If no confirmation is obtained from the user, a message is displayed on the displaying device 16 to notify the user of such (Step 308).

If the notification item is set for a repeated notification (Step 305), the central processing unit 13 determines if a number of times N that the notification has been played is 0, or if the user has supplied any confirmation (Step 309). If the answer is no, the portable electronic device will execute the voice data playing procedure shown in FIG. 4 (Step 310), and will decrement the number of times N of the notification (Step 311) and go back to the step 309. If the answer of step 309 is yes, the portable electronic device will check if the user gave any confirmation (Step 312). If no confirmation was obtained from the user, a notifying message will be displayed on the display device 16 to notify the user of such (Step 308).

According to above-mentioned description, it is known that the present portable electronic device capable of pre-recording voice data for notification can relate the notification items to pre-recorded voice data, and when the preset time is reached, the speaker plays the related pre-recorded voice data corresponding to the content of the notification event to notify the user. Therefore, the user can obtain the content of the notification event when the machine is off, or without interruption when the machine is operating.

Although the present invention has been explained in relation to its preferred embodiment, it is to be understood that many other possible modifications and variations can be made without departing from the spirit and scope of the invention as hereinafter claimed.

What is claimed is:

1. A portable electronic device capable of pre-recording voice data for notification, comprising:
a microphone for receiving voice data from a user;
a speaker for playing the voice data;
a voice data processor for processing the received voice data and the voice data to be played;
a non-volatile memory for storing at least one notification item, at least one notification time, and the corresponding voice data pre-recorded by the user via the microphone;
a central processing unit for searching voice data related to a notification item from the non-volatile memory when the notification time is reached, and sending the voice data to the speaker for being played, so as to notify the user.

2. The device as claimed in claim 1, wherein the notification item is capable of being set for a single notification or a repeated notification.

3. The device as claimed in claim 2, wherein, if the portable electronic device is off at the notification time, power for the portable electronic device is first turned on, and a display device of the portable electronic device is turned on.

4. The device as claimed in claim 3, wherein the central processing unit searches the voice data from the non-volatile memory and plays the voice data via the speaker to notify the user.

5. The device as claimed in claim 4, wherein if no confirmation is received after playing the notification voice data, a notification message is displayed on the display device.

6. The device as claimed in claim 3, wherein if the notification item is set for the repeated notification, the portable electronic device plays the notification repeatedly until a confirmation is received from the user.

7. The device as claimed in claim 6, wherein if no confirmation is received from the user, a notifying message is displayed on the display device.
